(19) United States
(12) Patent Application Publication
(10) Pub. No.: US 2014/0354777 A1
(43) Pub. Date: Dec. 4, 2014

(54) APPARATUS AND METHOD FOR OBTAINING SPATIAL INFORMATION USING ACTIVE ARRAY LENS

(71) Applicant: Electronics and Telecommunications Research Institute, Daejeon (KR)

(72) Inventors: Hyun LEE, Daejeon (KR); Gwang Soon LEE, Daejeon (KR); Eung Don LEE, Daejeon (KR); Yang Su KIM, Daejeon (KR); Jae Han KIM, Gwacheon-si Gyeonggi-do (KR); Jin Hwan LEE, Daejeon (KR); Nam Ho HUR, Daejeon (KR)

(73) Assignee: Electronics and Telecommunications Research Institute, Daejeon (KR)

(21) Appl. No.: 14/290,445

(22) Filed: May 29, 2014

(30) Foreign Application Priority Data
May 29, 2013 (KR) 10-2013-0061199
May 22, 2014 (KR) 10-2014-0061883

(51) Int. Cl. H04N 5/232; H04N 13/02

(52) U.S. Cl. CPC H04N 5/23212; H04N 13/025
USPC 348/46; 348/349

(57) ABSTRACT

Disclosed herein are an apparatus and method for obtaining spatial information using an active array lens. In order to obtain spatial information in the apparatus for obtaining spatial information including the active microlens, at least one active pattern for varying a microlens' focus is determined by controlling voltage applied to a pattern of the active microlens, and at least one projection image captured by the at least one active pattern is obtained in a time-division unit.

This application claims priority to Korean Patent Application No. 10-2014-0061883 filed on May 22, 2014 and No. 10-2013-0061199 filed on May 29, 2013, the contents of which are herein incorporated by reference in its entirety.

### BACKGROUND OF THE INVENTION

1. Field of the Invention

The present invention relates to an apparatus and method for obtaining spatial information using an active array lens and, more particularly, to an apparatus and method for obtaining spatial information using an active array lens, which are capable of simultaneously providing two-dimensional (2D) and three-dimensional (3D) images of high resolution and improving resolution of 3D spatial information in a method of obtaining 3D spatial information using a light field camera including the active array lens.

2. Discussion of the Related Art

In general, a 2D camera does not provide 3D spatial information because it obtains an image through a single lens. In order to solve this problem, research is recently being carried out on a plenoptic camera having a function of recombining focuses. The plenoptic camera is also called a light field camera.

In such a light field camera, a microlens is disposed in front of an image sensor and is configured to obtain element images in several directions and obtain a multi-viewpoint image by converting the element images into 3D spatial information using an interpolation method or image signal processing, thereby improving resolution and picture quality.

However, such a light field camera method is problematic in that a 2D image of maximum resolution in the image sensor cannot be captured by the light field camera because the microlens is fixed and thus resolution of the element images, that is, 3D spatial information, is deteriorated.

Accordingly, there is a need for an image acquisition technology using a light field camera, which is capable of simultaneously providing 2D and 3D images having maximum resolution and improving resolution of element images, that is, 3D spatial information.

### PRIOR ART DOCUMENT

### Patent Document

(Patent Document 1) Korean Patent Application Publication No. 2011-0030259 entitled “Apparatus and Method for Processing Light Field Data using Mask with Attenuation Pattern” by Samsung Electronics Co., Ltd. (Nov. 17, 2011)

### SUMMARY OF THE INVENTION

An object of the present invention is to provide an apparatus and method for obtaining spatial information using an active array lens, which are capable of simultaneously providing 2D and 3D images of high resolution and improving resolution of 3D spatial information in a method of obtaining 3D spatial information using a light field camera including the active array lens.

Effects that may be achieved by the present invention are not limited to the above-described effects, and those skilled in the art to which the present invention pertains will readily appreciate other effects that have not been described from the following description.

In accordance with an aspect of the present invention, there is provided a method of obtaining spatial information in a spatial information acquisition apparatus, including an active microlens includes determining at least one active pattern for varying a microlens' focus based on control of voltage applied to a pattern of the active microlens and obtaining at least one projection image captured by the at least one active pattern in a time-division unit.

The method may further include generating an output image based on results obtained by composing the image obtained in a time-division unit, wherein the output image includes at least one of a multi-focus image, a free viewpoint image, a 2D image, a 3D image, and a 3D spatial information image.

Determining the at least one active pattern includes controlling the ON/OFF and refractive indices of the at least two patterns by controlling voltage applied to at least two patterns of the active microlens.

Controlling the refractive indices includes generating a first active pattern using a first pattern that belongs to the at least two patterns and that becomes ON, generating a second active pattern using a second pattern that belongs to the at least two patterns and that becomes ON, generating a third active pattern by varying the refractive index of the first active pattern or the second active pattern, and generating a fourth active pattern by simultaneously making OFF the first active pattern and the second active pattern or changing the refractive index of the first active pattern or the second active pattern to a value at which a focal distance becomes infinite.

Obtaining the at least one projection image in a time-division unit includes controlling a point of time at which a first projection image captured by the first active pattern is projected, controlling a point of time at which a second projection image captured by the second active pattern is projected, and generating a first time-division image by alternately obtaining the first projection image and the second projection image in a time-division unit.

Obtaining the at least one projection image in a time-division unit includes controlling a point of time at which a first projection image captured by the first active pattern is projected, controlling a point of time at which a third projection image captured by the third active pattern is projected if the second active pattern operates like the third active pattern by varying the refractive index of the second active pattern, and generating a second time-division image by alternately obtaining the first projection image and the third projection image in a time-division unit.

Obtaining the at least one projection image in a time-division unit includes controlling a point of time at which a first projection image captured by the first active pattern is projected, controlling a point of time at which a fourth projection image captured by the fourth active pattern is projected if the refractive index of the second active pattern is changed to a value at which a focal distance becomes infinite and the second active pattern operates like the fourth active pattern, and generating a third time-division image by alternately obtaining the first projection image and the fourth projection image in a time-division unit.

Obtaining the at least one projection image in a time-division unit includes controlling a point of time at which a fourth projection image captured by the fourth active pattern generated by simultaneously making OFF the first active pattern and the second active pattern is projected and generating a fourth time-division image by alternately obtaining the fourth active pattern in a time-division unit.

Generating the output image includes combining and interpolating first to fourth time-division images generated by the first to the fourth active patterns.

In accordance with another aspect of the present invention, there is provided an apparatus for obtaining space information, including an active microlens configured to include at least two patterns and a lens controller configured to determine at least one active pattern for varying a microlens' focus based on control of voltage applied to the at least two patterns and to generate at least one projection image in a time-division unit.

The apparatus further includes an image sensor configured to obtain the at least one projection image transferred through the active microlens and an image signal processor configured to generate an output image using a time-division image obtained in the time-division unit.

The active microlens includes an active array lens disposed so that at least two patterns cross each other, and the ON/OFF and refractive index of the active microlens are controlled in response to voltage applied though the lens controller.

The lens controller is configured to perform control so that a first active pattern is generated by controlling voltage applied to the first pattern of the at least two patterns, so that a second active pattern is generated by controlling voltage applied to the second pattern of the at least two patterns other than the first pattern, so that a third active pattern is generated by varying the refractive index of the first active pattern or the second active pattern, and so that a fourth active pattern is generated by changing the refractive index of the first active pattern or the second active pattern to a value at which a focal distance becomes infinite or simultaneously making OFF the first active pattern and the second active pattern.

The lens controller is configured to control points of time at which a first projection image and a second projection image are projected onto the image sensor so that the first projection image captured by the first active pattern and the second projection image captured by the second active pattern are alternately generated in a time-division unit.

The lens controller is configured to perform control so that the second active pattern operates like the third active pattern by varying the refractive index of the second active pattern and to control points of time at which a first projection image and a third projection image are projected onto the image sensor so that the first projection image captured by the first active pattern and the third projection image captured by the third active pattern are alternately generated in a time-division unit.

The lens controller is configured to perform control so that the second active pattern operates like the fourth active pattern by changing the refractive index of the second active pattern to a value at which the focal distance becomes infinite and to control points of time at which a first projection image and a fourth projection image are projected onto the image sensor so that the first projection image captured by the first active pattern and the fourth projection image captured by the fourth active pattern are alternately generated in a time-division unit.

The lens controller is configured to simultaneously make OFF the first active pattern and the second active pattern so that the fourth active pattern is generated and to control a point of time at which a fourth projection image is projected onto the image sensor so that the fourth projection image captured by the fourth active pattern is alternately generated in a time-division unit.

The image signal processor is configured to generate first to fourth time-division images using the first to the fourth projection images transferred by the image sensor in a time-division unit.

The image signal processor is configured to generate the output image by combining and interpolating the first to the fourth time-division images.

The output image includes at least one of a multi-focus image, a free viewpoint image, a 2D image, a 3D image, and a 3D spatial information image.

### BRIEF DESCRIPTION OF THE DRAWINGS

FIG. 1 is a diagram illustrating a common 2D camera;

FIG. 2 is a diagram illustrating a common light field camera;

FIG. 3 is a diagram illustrating a method of obtaining an image in a common plenoptic-based light field camera;

FIG. 4 is a schematic diagram illustrating an apparatus for obtaining spatial information using an active array lens in accordance with an embodiment of the present invention;

FIG. 5 is a diagram illustrating an example of a schematic structure of an active microlens in accordance with an embodiment of the present invention;

FIG. 6 is a diagram illustrating an example in which the refractive index of the active microlens is changed in accordance with an embodiment of the present invention;

FIG. 7 is a diagram illustrating an example in which an active pattern is determined by changing a photographing focus in accordance with an embodiment of the present invention;

FIG. 8 is a diagram illustrating a method of obtaining spatial information in accordance with an embodiment of the present invention; and

FIG. 9 is a flowchart illustrating a method of obtaining spatial information in accordance with an embodiment of the present invention.

### DETAILED DESCRIPTION OF THE EMBODIMENTS

The present invention may be modified in various ways and may have multiple embodiments, and thus specific embodiments will be illustrated in the drawings and described in detail.

It is however to be understood that the specific embodiments are not intended to limit the present invention and the embodiments may include all changes, equivalents, and substitutions that are included in the spirit and technical scope of the present invention.

Terms, such as the first and the second, may be used to describe a variety of elements, but the elements should not be limited by the terms. The terms are used to only distinguish one element from the other element. For example, a first element may be named a second element, and likewise a second element may be named a first element without departing from the scope of the present invention. A term “and/or” includes a combination of a plurality of related and described items or any one of the plurality of related and described items.

When it is said that one element is described as being “connected” to or “coupled” with the other element, the one element may be directly connected to or coupled with the other element, but it should be understood that a third element may be interposed between the two elements. In contrast, when it is said that one element is described as being “directly connected” to or “directly coupled” with the other element, it should be understood that a third element is not present between the two elements.

Terms used in this application are used to describe only specific embodiments and are not intended to limit the present invention. An expression of the singular number should be understood to include plural expressions, unless clearly expressed otherwise in the context. It should be understood that in this application, terms, such as “include” or “have”, are intended to designate the existence of described characteristics, numbers, steps, operations, elements, parts, or combination of them and understood, but are not intended to exclude the existence of one or more other characteristics, numbers, steps, operations, elements, parts, or a combination of them or the possibility addition of them.

All terms used herein, including technical or scientific terms, have the same meanings as those typically understood by those skilled in the art unless otherwise defined. Terms, such as ones defined in common dictionaries, should be construed as having the same meanings as those in the context of related technology and should not be construed as having ideal or excessively formal meanings unless clearly defined in this application.

Hereinafter, some exemplary embodiments of the present invention are described in more detail with reference to the accompanying drawings. In describing the present invention, in order to help general understanding, the same reference numerals are used to denote the same elements throughout the drawings, and a redundant description of the same elements is omitted.

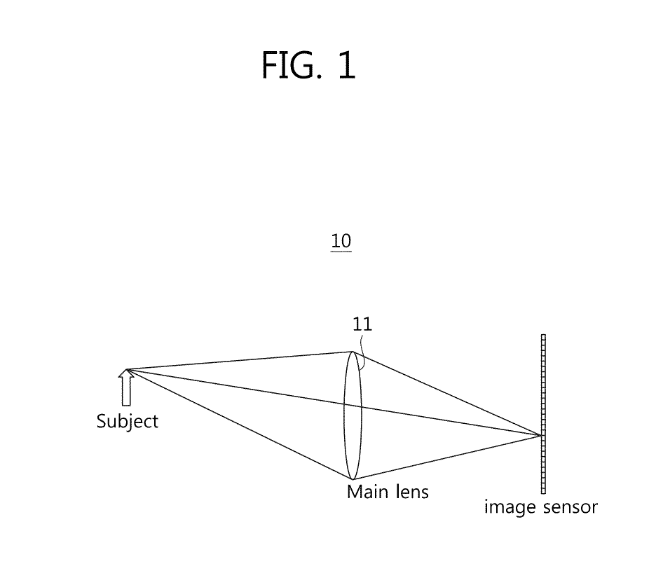

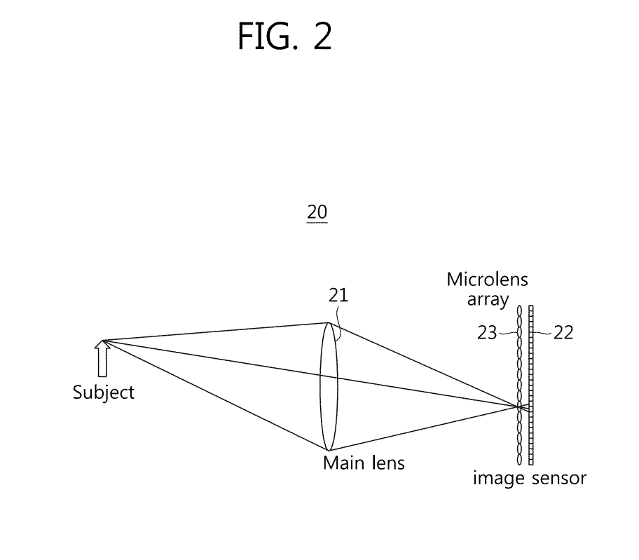

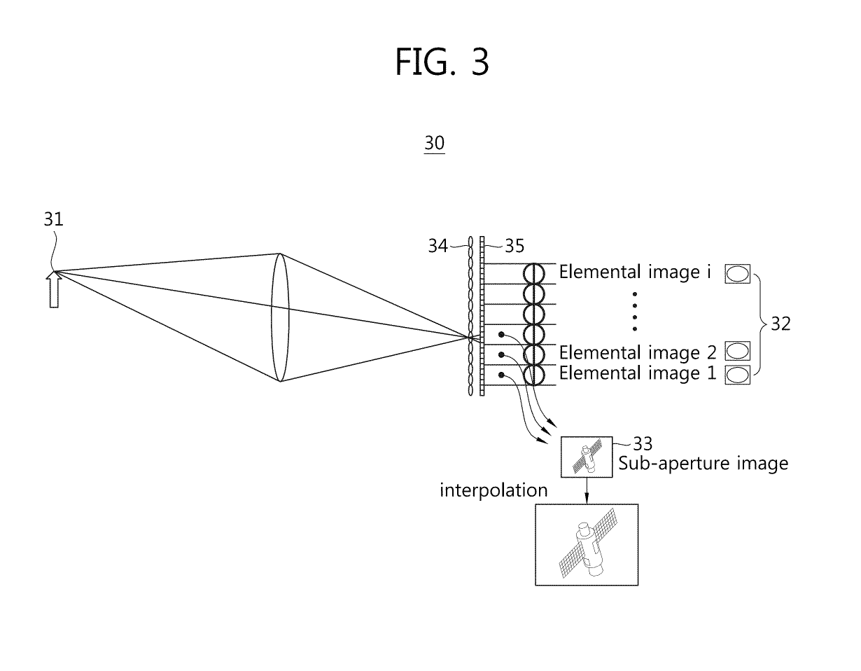

FIG. 1 is a diagram illustrating a common 2D camera. FIG. 2 is a diagram illustrating a common light field camera. FIG. 3 is a diagram illustrating a method of obtaining an image in a common plenoptic-based light field camera.

Referring to FIGS. 1 and 2, a common 2D camera 10 does not obtain 3D spatial information because it obtains an image through a single lens 11. In contrast, a light field camera 20 includes a microlens array 23 disposed in front of an image sensor 22 in the space between a lens 21 and the image sensor 22, and is configured to obtain element images transferred in several directions and obtain a multi-viewpoint image by converting the element images into 3D spatial information using an interpolation method or image signal processing.

For example, as shown in FIG. 3, in a common plenoptic-based light field camera (30) method, a sub-aperture image 33 corresponding to a viewpoint image is obtained using element images 32, that is, image information in the direction at a specific point of a subject 31, and an image generated by recombining pixels in all the element images according to each location. In the plenoptic-based light field camera (30) method, resolution and picture quality are improved using an interpolation method, such as super-resolution. As described above, in the plenoptic-based light field camera (30) method, the viewpoint image 33 is generated by recombining pixels at each of the locations of the element images 32. Accordingly, the number of viewpoints is determined by the number of pixels of the element images 32, and resolution of the sub-aperture image 33 is determined by the number of microlenses 34. Furthermore, in the plenoptic-based light field camera (30) method, the number of viewpoints and resolution of the element images have a trade-off relation because all the pixels of an image sensor 35 is determined by pixels divided by the number of microlenses 34.

As described above, the common plenoptic-based light field camera (30) method has a problem in that a 2D image of maximum resolution in the image sensor 35 cannot be captured using a light field camera because the fixed microlens 34 is used. In other words, since the element images are obtained and the viewpoint image is generated using the fixed microlens 34, resolution of each viewpoint image, that is, the sub-aperture image 33, is deteriorated compared to the case where all the pixels of images that may be obtained by all the image sensors are used.

In addition to the light field camera based on the aforementioned plenoptic sampling method, other light field cameras based on an Integral Photograph (IP) sampling method has the same problem in that resolution is deteriorated due to the fixed microlens 34.

Hereinafter, an apparatus and method for obtaining spatial information using an active array lens to which a light field camera method of changing a focus in response to an electrical signal has been applied in accordance with an embodiment of the present invention instead of the fixed microlens in order to solve the problems are described in detail.

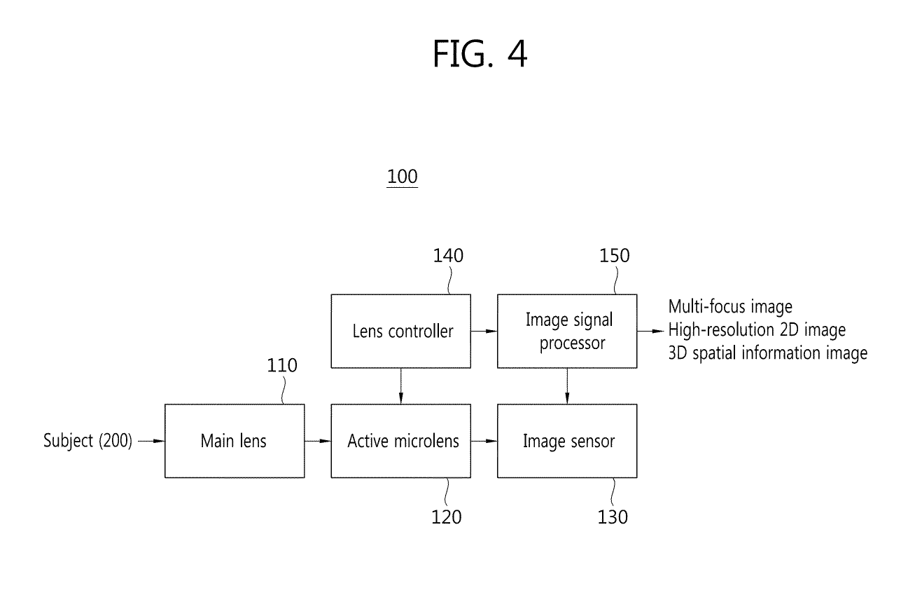

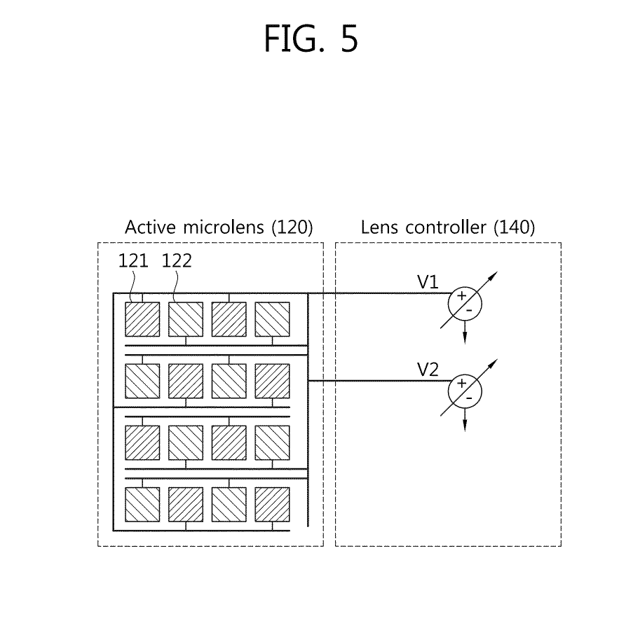

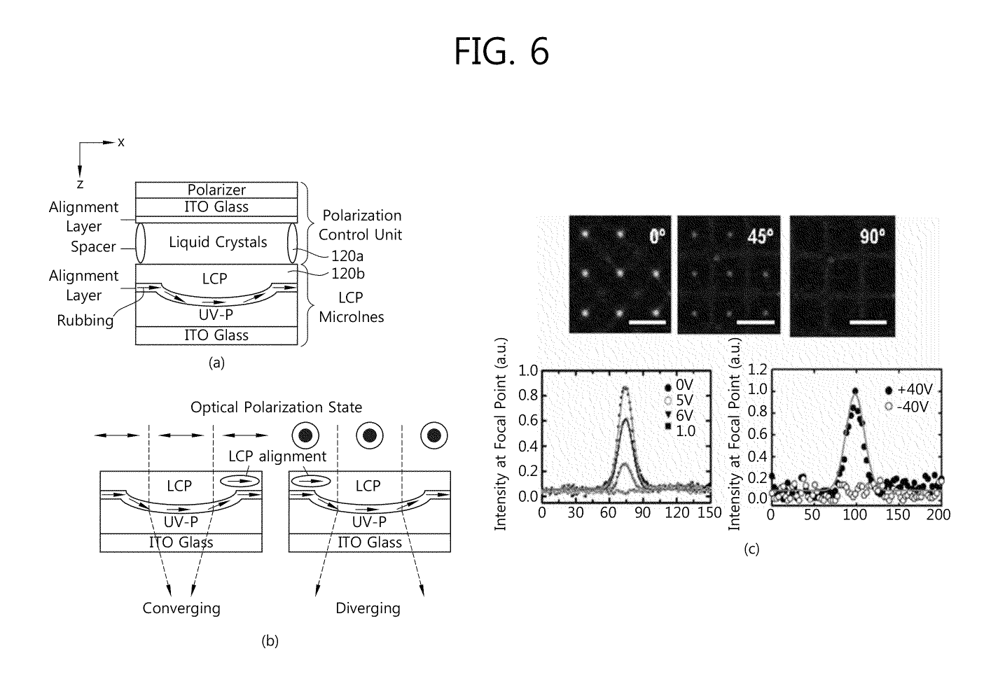

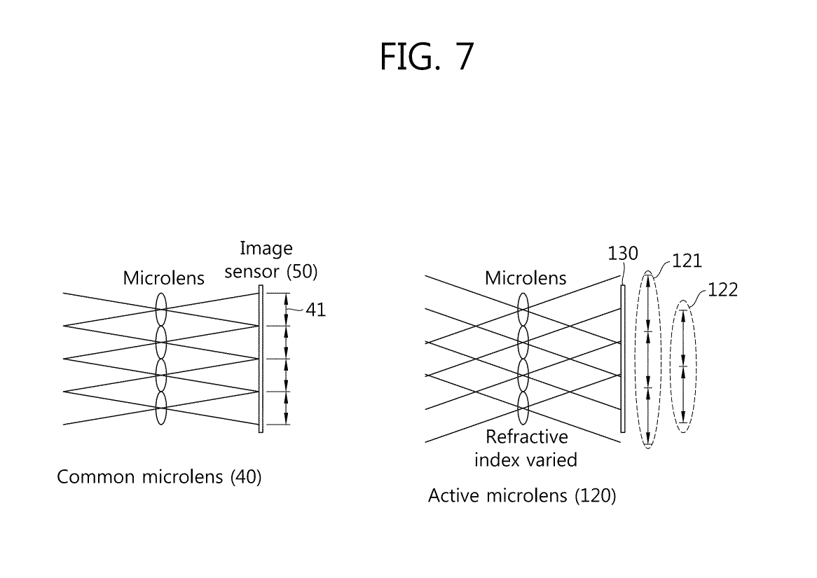

FIG. 4 is a schematic diagram illustrating an apparatus for obtaining spatial information using an active array lens in accordance with an embodiment of the present invention. FIG. 5 is a diagram illustrating an example of a schematic structure of an active microlens in accordance with an embodiment of the present invention. FIG. 6 is a diagram illustrating an example in which the refractive index of the active microlens is changed in accordance with an embodiment of the present invention. FIG. 7 is a diagram illustrating an example in which an active pattern is determined by changing a photographing focus in accordance with an embodiment of the present invention.

As shown in FIG. 4, the apparatus for obtaining spatial information using an active array lens (hereinafter referred to as the “spatial information acquisition apparatus”) 100 in accordance with an embodiment of the present invention includes a main lens 110, an active microlens 120, an image sensor 130, a lens controller 140, and an image signal processor 150. In this spatial information acquisition apparatus 100, an image of a subject 200 is projected onto the image sensor 130 through the main lens 110 and the active microlens 120.

The active microlens 120 is an active array lens. As shown in FIG. 5, patterns 121 and 122 are disposed in the active microlens 120 so that they cross each other. The ON and OFF of the patterns 121 and 122 are controlled in response to voltages V1 and V2 that are applied to the patterns 121 and 122 through the lens controller 140. For example, when the voltage V1 is applied through the lens controller 140, the patterns 121 of the patterns 121 and 122 disposed in the active microlens 120 become ON. In contrast, when the voltage V1 is not applied, the patterns 121 become OFF. Likewise, when the voltage V2 is applied through the lens controller 140, the patterns 122 of the patterns 121 and 122 disposed in the active microlens 120 become ON. In contrast, when the voltage V2 is not applied, the patterns 122 become OFF. In this case, as shown in FIG. 6(a), in the active microlens 120, the polarization direction of light that is incident on Liquid Crystalline Polymer (LCP) is controlled in response to voltage applied to the Liquid Crystals (LC) 120a of the patterns 121 and 122. Thus, as shown in FIG. 6(b), the refractive index of the active microlens 120 is changed by the polarization of the incident light, and thus the focus of the active microlens 120 is varied. Accordingly, as shown in FIG. 6(c), the refractive index of the active microlens 120 is controlled, for example, 0°, 45°, or 90°, and thus the focus thereof is varied. In an embodiment of the present invention, in addition to the aforementioned method, the focus of the active microlens 120 may be varied using various active microlens methods.

Referring back to FIG. 4, the image sensor 130 obtains projection images including element images of the subject 200 that are transferred through the main lens 110 and the active microlens 120. More specifically, the image sensor 130 obtains projection images including element images of four patterns, such as a projection image in which only the patterns 121 become ON in response to voltage applied to the patterns 121 and 122 of the active microlens 120 by the lens controller 140, a projection image in which only the patterns 122 become ON in response to voltage applied to the patterns 121 and 122 of the active microlens 120 by the lens controller 140, a projection image according to a change of the refractive index of the active microlens 120, and a projection image in which both the patterns 121 and 122 are OFF. The image sensor 130 transfers the projection images, alternately obtained in a time-division unit, to the image signal processor 150.

For example, referring to FIGS. 5 and 7, an image sensor 50 obtains an image 41 through a common microlens 40, that is, a single lens. In contrast, if the active microlens 120 is disposed in front of the image sensor 130 and the lens controller 140 controls voltage applied to the patterns 121 of the active microlens 120, the image sensor 130 obtains projection images of first active patterns because only the patterns 121 become ON. If the lens controller 140 controls voltage applied to the patterns 122, the image sensor 130 obtains projection images of second active patterns because only the patterns 122 become ON. If the lens controller 140 performs control by changing the refractive indices of the patterns 121 and 122 so that the patterns 121 and 122 operate as third active pattern, the image sensor 130 obtains projection images of the third active patterns. If the patterns 121 and 122 become OFF at the same time or the refractive indices of the patterns 121 and 122 are changed to values equal to that of glass because the lens controller 140 does not apply voltage to the patterns 121 and 122, that is, the lens controller 140 performs control so that the refractive indices of the patterns 121 and 122 are changed to values at which a focal distance becomes infinite and the patterns 121 and 122 operate as fourth active patterns, the image sensor 130 obtains images of the fourth active patterns. The image sensor 130 transfers the element images of the four active patterns to the image signal processor 150. In an embodiment of the present invention, the first to the fourth active patterns are determined by varying a photographing focus in response to an electrical signal applied to the active array lens to which the light field camera method has been applied. An example of element images generated in a time-division unit through the first to the fourth active patterns is described in detail below.

Referring back to FIG. 4, the image signal processor 150 receives the element images of the respective active patterns from the image sensor 130. The image signal processor 150 generates various output images, such as a multi-focus image, a high-resolution 2D image, and a 3D spatial information image, based on the element images of the active patterns.

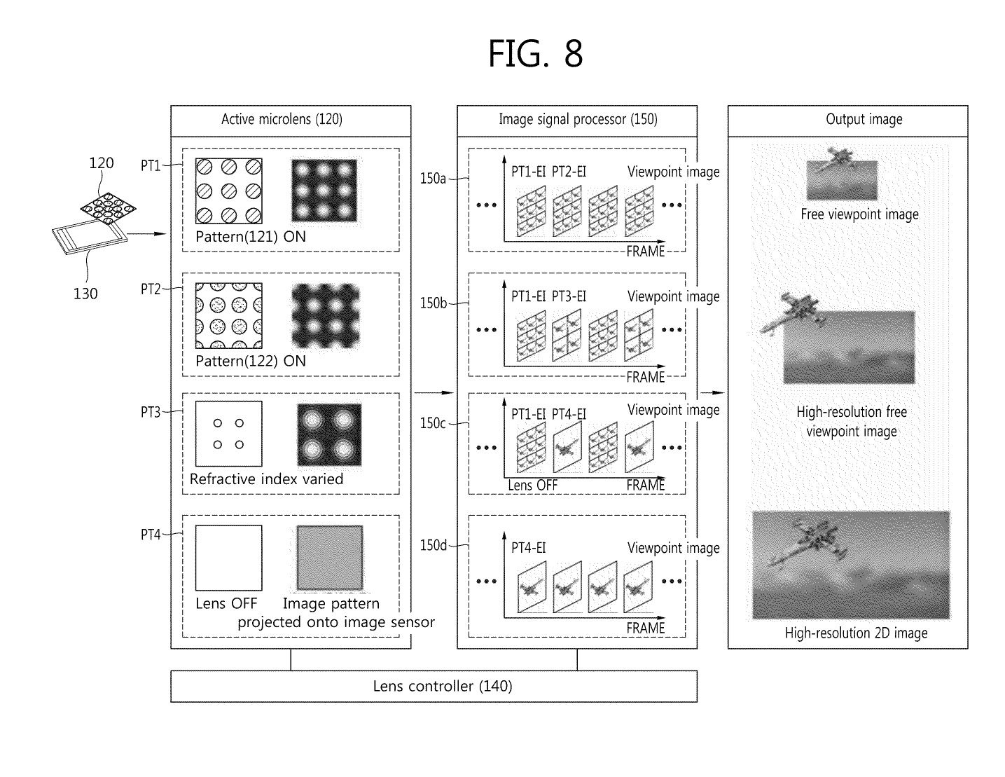

FIG. 8 is a diagram illustrating a method of obtaining spatial information in accordance with an embodiment of the present invention.

Referring to FIGS. 7 and 8, the spatial information acquisition apparatus 100 in accordance with an embodiment of the present invention obtains four cases of projection images PT1-EI to PT4-EI in a time-division unit that are captured by first to fourth active patterns PT1 to PT4 by controlling the patterns 121 and 122 of the active microlens 120, generates first to fourth time-division images 150a to 150d using the four cases of projection images, and generates various output images, such as a multi-focus image, a high-resolution 2D image, and a 3D spatial information image, by composing the first to fourth time-division images 150a to 150d in various numbers of cases. In an embodiment of the present invention, the projection images have been illustrated as being the four types, but the present invention is not limited thereto. Various projection images including at least one element image may be generated by controlling voltage applied to the active patterns.

More specifically, the lens controller 140 controls the ON/OFF and refractive indices of the patterns 121 and 122 by controlling voltage applied to the patterns 121 and 122 of the active microlens 120 so that the projection images PT1-EI to PT4-EI captured by the first to the fourth active patterns PT1 to PT4 are generated by the image sensor 130 in a time-division unit. The image sensor 130 obtains the projection images PT1-EI to PT4-EI captured by the first to the fourth active patterns PT1 to PT4 that alternately become ON or OFF in a time-division unit, and transfers the obtained projection images PT1-EI to PT4-EI to the image signal processor 150. The image signal processor 150 receives the projection images PT1-EI to PT4-EI in a time-division unit, generates the first to the fourth time-division images 150a to 150d using the received projection images, and generates an output image by combining the first to the fourth time-division images 150a to 150d in various ways.

For example, in order to solve a problem in that resolution of element images divided according to each viewpoint is restricted because effective resolution projected onto the image sensor 130 is limited due to the overlapping of the patterns 121 and 122 when the patterns 121 and 122 simultaneously become ON and are photographed in a conventional single pattern, the lens controller 140 controls points of time at which the first active pattern PT1 and the second active pattern PT2 are projected onto the image sensor 130 so that the first active pattern PT1 does not overlap with the second active pattern PT2. That is, the lens controller 140 controls voltage applied to the first active pattern PT1 and the second active pattern PT2 of the active microlens 120 so that the first active pattern PT1 and the second active pattern PT2 alternately becomes ON and OFF in a time-division unit. The lens controller 140 controls points of time at which the projection images PT1-EI captured by the first active pattern PT1 and the projection image PT2-EI captured by the second active pattern PT2 are projected onto the image sensor 130. In this case, the image sensor 130 obtains the projection image PT1-EI and the projection image PT2-EI using the first active pattern PT1 and the second active pattern PT2 that alternately become ON and OFF in a time-division unit, and transfers the obtained projection image PT1-EI and the projection image PT2-EI to the image signal processor 150. The image signal processor 150 receives the projection image PT1-EI and the projection image PT2-EI from the image sensor 130 in a time-division unit, and generates the first time-division image 150a using the projection image PT1-EI and the projection image PT2-EI. As described above, in an embodiment of the present invention, since overlapping does not occur due to time-division photographing, resolution of element images captured by the first active pattern PT1 and the second active pattern PT2, respectively, can be improved compared to the prior art, and thus the number of viewpoints or effective resolution can be increased.

For another example, the lens controller 140 improves resolution by controlling the refractive index of the first active pattern PT1 or the second active pattern PT2 so that the refractive index is varied. In an embodiment of the present invention, the refractive index of the second active pattern PT2 is assumed to be varied. If the refractive index of the second active pattern PT2 is varied, the number of active microlenses 120 can be reduced by electrical switching, and the refractive index of a conventional microlens is changed. Accordingly, space resolution of a subject can be improved because a focal distance is increased to the extent that pieces of image information do not overlap with each other using a method of increasing the focal distance. That is, the lens controller 140 performs control by varying the refractive index of the second active pattern PT2 to the extent that pieces of image information do not overlap with each other so that the second active pattern PT2 operates like the third active pattern PT3. Furthermore, the lens controller 140 controls voltage applied to the first active pattern PT1 and the third active pattern PT3 so that the first active pattern PT1 and the third active pattern PT3 alternately become ON and OFF in a time-division unit. The lens controller 140 control points of time at which the projection image PT1-EI captured by the first active pattern PT1 and the projection image PT3-EI captured by the third active pattern PT3 are projected onto the image sensor 130. The image sensor 130 obtains the projection image PT1-EI and the projection image PT3-EI using the first active pattern PT1 and the third active pattern PT3 that alternately become ON and OFF in a time-division unit, and transfers the projection image PT1-EI and the projection image PT3-EI to the image signal processor 150. The image signal processor 150 receives the projection image PT1-EI and the projection image PT3-EI in a time-division unit from the image sensor 130, and generates the second time-division image 150b using the received projection images. As described above, in an embodiment of the present invention, the projection image PT2-EI is rearranged by varying the refractive index of the second active pattern PT2. Accordingly, the number of sub-aperture images is reduced along with the projection image PT3-EI and thus a total number of viewpoint images are reduced, but resolution of the viewpoint image can be increased.

For yet another example, the lens controller 140 improves resolution by controlling the refractive index of the first active pattern PT1 or the second active pattern PT2 so that the focal distance of the first active pattern PT1 or the second active pattern PT2 becomes infinite. In an embodiment of the present invention, it is assumed that the refractive index of the second active pattern PT2 is changed to a value at which the focal distance becomes infinite. If the refractive index of the second active pattern PT2 is controlled so that the focal distance of the second active pattern PT2 becomes infinite as described above, the second active pattern PT2 operates like the fourth active pattern PT4, and the active microlens 120 operates in the OFF state at a point of time at which the second active pattern PT2 is subject to time-division. Accordingly, an image captured by the second active pattern PT2, that is, the fourth active pattern PT4, has the same condition as a captured 2D image. That is, the lens controller 140 varies the refractive index of the second active pattern PT2 so that the focal distance of the second active pattern PT2 becomes infinite and thus the second active pattern PT2 operates like the fourth active pattern PT4. Furthermore, the lens controller 140 controls voltage applied to the first active pattern PT1 and the fourth active pattern PT4 so that the first active pattern PT1 and the fourth active pattern PT4 alternately become ON and OFF in a time-division unit. The lens controller 140 controls points of time at which the projection image PT1-EI captured by the first active pattern PT1 and the projection image PT4-EI captured by the fourth active pattern PT4 are projected onto the image sensor 130. The image sensor 130 obtains the projection image PT1-EI and the projection image PT4-EI captured by the first active pattern PT1 and the fourth active pattern PT4 that alternately become ON and OFF in a time-division unit, and transfers the projection image PT1-EI and the projection image PT4-EI to the image signal processor 150. The image signal processor 150 receives the projection image PT1-EI and the projection image PT4-EI in a time-division unit from the image sensor 130, and generates the third time-division image 150c using the received projection mages. As described above, in an embodiment of the present invention, the third time-division image 150c including element images of high resolution can be obtained using an element image of the projection image PT1-EI and a 2D image of the projection image PT4-EI.

For yet another example, the lens controller 140 captures a 2D image of high resolution by performing control so that both the first active pattern PT1 and the second active pattern PT2 become OFF. That is, the lens controller 140 controls voltage applied to the first active pattern PT1 and the second active pattern PT2 so that both the first active pattern PT1 and the second active pattern PT2 become OFF and alternately operate as the fourth active pattern PT4 in a time-division unit. When both the first active pattern PT1 and the second active pattern PT2 become OFF as described above, the active microlens 120 operates in the OFF state in all time-division viewpoints, and thus a captured image has the same condition as a captured 2D image. The lens controller 140 controls a point of time at which the projection image PT4-EI captured by the fourth active pattern PT4 is projected onto the image sensor 130. The image sensor 130 obtains the projection images PT4-EI alternately captured by the fourth active pattern PT4 in a time-division unit, and transfers the obtained projection images to the image signal processor 150. The image signal processor 150 receives the projection images PT4-EI in a time-division unit from the image sensor 130 and generates the fourth time-division image 150d using the received projection images. As described above, in an embodiment of the present invention, the fourth time-division image 150d including a 2D image of high resolution can be obtained using the 2D image of the projection images PT4-EI transferred in a time-division unit.

When the generation of the first to the fourth time-division images 150a to 150d is completed as described above, the image signal processor 150 generates various output images, such as a free viewpoint image, a high-resolution free viewpoint image, and a high-resolution 2D image, by combining and interpolating the first to the fourth time-division images 150a to 150d in various ways.

As described above, in an embodiment of the present invention, a high-resolution 2D image and a viewpoint image, such as the third time-division image 150c, can be obtained at the same time by varying the refractive index and driving the OFF of the microlens in a time-division unit. Furthermore, picture quality of a viewpoint image can be improved more sharply by properly interpolating a 2D image, such as the fourth time-division image 150d obtained by the OFF of the microlens, and a viewpoint image, such as the second time-division image 150b obtained by varying the refractive index.

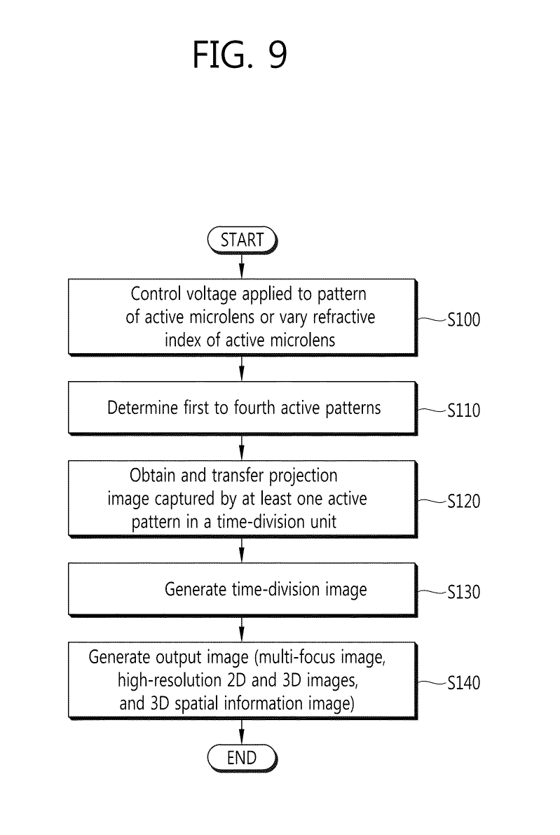

FIG. 9 is a flowchart illustrating a method of obtaining spatial information in accordance with an embodiment of the present invention.

As shown in FIG. 9, the lens controller 140 of the spatial information acquisition apparatus 100 in accordance with an embodiment of the present invention varies the ON/OFF and refractive indices of the patterns 121 and 122 of the active microlens 120 by controlling voltage applied to the patterns 121 and 122 at step S100, and determines the first to the fourth active patterns PT1 to PT4 of the active microlens 120 at step S110.

The lens controller 140 controls voltage applied to at least one active pattern of the first to the fourth active patterns PT1 to PT4 so that at least one active pattern is alternately generated in a time-division unit. In this case, a projection image captured by the at least one active pattern is alternately generated by the image sensor 130 in a time-division unit. The image sensor 130 obtains the at least one projection image that has been alternately generated in a time-division unit, and transfers the at least one projection image to the image signal processor 150 at step S120.

The image signal processor 150 alternately receives the at least one projection image in a time-division unit from the image sensor 130. The image signal processor 150 generates a time-division image using the at least one projection image at step S130. When at least two time-division images are generated by repeatedly performing the above process, the image signal processor 150 generates various output images, such as a multi-focus image, a free viewpoint image, a high-resolution 2D image, a high-resolution 3D image, and a 3D spatial information image, by composing the time-division images in various numbers of cases or using each of the time-division images at step S140.

In accordance with the apparatus and method for obtaining spatial information using an active array lens, unlike in a conventional fixed microlens, the active array lens having a photographing focus varied in response to an electrical signal is disposed in front of the image sensor. Resolution of an element image can be improved and the number of viewpoints or effective resolution can be increased because a projection image of an active pattern is alternately obtained in a time-division unit. Accordingly, 2D and 3D images of high resolution can be simultaneously provided, and a problem in that resolution of an element image, that is, 3D spatial information, is deteriorated can be solved.

Although some embodiments of the present invention have been described with reference to the accompanying drawings, it is not intended to limit the scope of the present invention, and those skilled in the art may modify the present invention in various forms without departing from the spirit and scope of the present invention determined by the claims.

What is claimed is:

1. A method of obtaining spatial information in a spatial information acquisition apparatus comprising an active microlens, the method comprising:
determining at least one active pattern for varying a microlens' focus based on control of voltage applied to a pattern of the active microlens; and
obtaining at least one projection image captured by the at least one active pattern in a time-division unit.

2. The method of claim 1, further comprising generating an output image based on results obtained by composing the image obtained in a time-division unit,
wherein the output image comprises at least one of a multi-focus image, a free viewpoint image, a 2D image, a 3D image, and a 3D spatial information image.

3. The method of claim 1, wherein determining the at least one active pattern comprises controlling an ON/OFF and refractive indices of the at least two patterns by controlling voltage applied to at least two patterns of the active microlens.

4. The method of claim 3, wherein controlling the refractive indices comprises:
generating a first active pattern using a first pattern that belongs to the at least two patterns and that becomes ON;
generating a second active pattern using a second pattern that belongs to the at least two patterns and that becomes ON;
generating a third active pattern by varying a refractive index of the first active pattern or the second active pattern; and
generating a fourth active pattern by simultaneously making OFF the first active pattern and the second active pattern or changing a refractive index of the first active pattern or the second active pattern to a value at which a focal distance becomes infinite.

5. The method of claim 4, wherein obtaining the at least one projection image in a time-division unit comprises:
controlling a point of time at which a first projection image captured by the first active pattern is projected;
controlling a point of time at which a second projection image captured by the second active pattern is projected; and
generating a first time-division image by alternately obtaining the first projection image and the second projection image in a time-division unit.

6. The method of claim 4, wherein obtaining the at least one projection image in a time-division unit comprises:
controlling a point of time at which a first projection image captured by the first active pattern is projected;
controlling a point of time at which a third projection image captured by the third active pattern is projected if the second active pattern operates like the third active pattern by varying the refractive index of the second active pattern; and
generating a second time-division image by alternately obtaining the first projection image and the third projection image in a time-division unit.

7. The method of claim 4, wherein obtaining the at least one projection image in a time-division unit comprises:
controlling a point of time at which a first projection image captured by the first active pattern is projected;
controlling a point of time at which a fourth projection image captured by the fourth active pattern is projected if the refractive index of the second active pattern is changed to a value at which a focal distance becomes infinite and the second active pattern operates like the fourth active pattern; and
generating a third time-division image by alternately obtaining the first projection image and the fourth projection image in a time-division unit.

8. The method of claim 4, wherein obtaining the at least one projection image in a time-division unit comprises:
controlling a point of time at which a fourth projection image captured by the fourth active pattern generated by simultaneously making OFF the first active pattern and the second active pattern is projected; and
generating a fourth time-division image by alternately obtaining the fourth active pattern in a time-division unit.

9. The method of claim 4, wherein generating the output image comprises combining and interpolating first to fourth time-division images generated by the first to the fourth active patterns.

10. An apparatus for obtaining space information, comprising:
an active microlens configured to comprise at least two patterns; and
a lens controller configured to determine at least one active pattern for varying a microlens' focus based on control of voltage applied to the at least two patterns and to generate at least one projection image in a time-division unit.

11. The apparatus of claim 10, further comprising:
an image sensor configured to obtain the at least one projection image transferred through the active microlens; and
an image signal processor configured to generate an output image using a time-division image obtained in the time-division unit.

12. The apparatus of claim 11, wherein:
the active microlens comprises an active array lens disposed so that at least two patterns cross each other, and
an ON/OFF and refractive index of the active microlens are controlled in response to voltage applied though the lens controller.

13. The apparatus of claim 12, wherein the lens controller is configured to perform control so that a first active pattern is generated by controlling voltage applied to a first pattern of the at least two patterns, so that a second active pattern is generated by controlling voltage applied to a second pattern of the at least two patterns other than the first pattern, so that a third active pattern is generated by varying a refractive index of the first active pattern or the second active pattern, and so that a fourth active pattern is generated by changing the refractive index of the first active pattern or the second active pattern to a value at which a focal distance becomes infinite or simultaneously making OFF the first active pattern and the second active pattern.

14. The apparatus of claim 13, wherein the lens controller is configured to control points of time at which a first projection image and a second projection image are projected onto the image sensor so that the first projection image captured by the first active pattern and the second projection image captured by the second active pattern are alternately generated in a time-division unit.

15. The apparatus of claim 13, wherein the lens controller is configured to:
perform control so that the second active pattern operates like the third active pattern by varying the refractive index of the second active pattern; and
control points of time at which a first projection image and a third projection image are projected onto the image sensor so that the first projection image captured by the first active pattern and the third projection image captured by the third active pattern are alternately generated in a time-division unit.

16. The apparatus of claim 13, wherein the lens controller is configured to:
perform control so that the second active pattern operates like the fourth active pattern by changing the refractive index of the second active pattern to a value at which the focal distance becomes infinite; and
control points of time at which a first projection image and a fourth projection image are projected onto the image sensor so that the first projection image captured by the first active pattern and the fourth projection image captured by the fourth active pattern are alternately generated in a time-division unit.

17. The apparatus of claim 13, wherein the lens controller is configured to:
simultaneously make OFF the first active pattern and the second active pattern so that the fourth active pattern is generated; and
control a point of time at which a fourth projection image is projected onto the image sensor so that the fourth projection image captured by the fourth active pattern is alternately generated in a time-division unit.

18. The apparatus of claim 17, wherein the image signal processor is configured to generate first to fourth time-division images using the first to the fourth projection images transferred by the image sensor in a time-division unit.

19. The apparatus of claim 18, wherein the image signal processor is configured to generate the output image by combining and interpolating the first to the fourth time-division images.

20. The apparatus of claim 19, wherein the output image comprises at least one of a multi-focus image, a free viewpoint image, a 2D image, a 3D image, and a 3D spatial information image.
